(19) United States
(12) Patent Application Publication
(10) Pub. No.: US 2009/0148640 A1
(43) Pub. Date: Jun. 11, 2009

(54) GAS BARRIER COMPOSITE FILM FOR HYDROTHERMALLY PROCESSABLE PACKAGE AND PACKAGING BAG OBTAINED BY USING SAME

(75) Inventors: Junichi Yoshida, Osaka (JP); Yutaka Matsuoka, Osaka (JP); Yoshiaki Ueno, Osaka (JP); Masanori Kano, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SAKATA INX CORP., Osaka-shi, Osaka (JP)

(21) Appl. No.: 12/064,780

(22) PCT Filed: Aug. 23, 2006
(86) PCT No.: PCT/JP2006/316503

§ 371 Date: Sep. 23, 2008

(30) Foreign Application Priority Data
Aug. 24, 2005 (JP) 2005-243267

(51) Int. Cl. B32B 27/40; B65D 30/02

(52) U.S. Cl. 428/36.6; 428/423.1; 428/424.2; 428/201

(57) ABSTRACT

The present invention relates to a gas barrier composite film for a hydrothermally processable package,

wherein at least one gas barrier layer containing a gas barrier resin and an inorganic layered compound is interposed between a base film layer and a sealing material layer, and

an adhesive layer is further formed on both sides of the gas barrier layer by applying an adhesive composition comprising: a base material mainly comprising a polyurethane resin having at least one functional group selected from the group consisting of an amino group, a hydroxyl group, and a carboxyl group; and a curing agent comprising an isocyanate curing agent and an epoxy curing agent, at the following functional group ratio:

I/P=0.3 to 30.0

E/P=1.5 to 25.0

(here, “P” represents the total number of moles of primary and secondary amino groups, hydroxyl groups, and carboxyl groups contained in the base material, “I” represents the number of moles of isocyanate groups contained in the isocyanate curing agent, and “E” represents the number of moles of epoxy groups contained in the epoxy curing agent).

### TECHNICAL FIELD

The present invention relates to a gas barrier composite film for a hydrothermally processable package having excellent gas barrier properties and hydrothermal processability, and a packaging bag obtained by using the same.

### BACKGROUND ART

The functions of contents indication and decoration by printing are required of packaging bags used for food packaging, and furthermore a composite laminate film with a sealant layer being laminated so as to cover a printed layer has been utilized for the purpose of obtaining higher food hygiene so that the printed layer may not directly touch foods, a person's fingers, and the like. Moreover, there have been increasing cases of producing packaging bags that allows for easy cooking of contents packed with a bag by giving the function enabling a hydrothermal process (this process is generally called a boiling/retorting treatment) to the composite laminate film of this kind.

Since the boiling/retorting treatment has a high sterilization effect and a packaging container is hermetically sealed, the treatment is an effective means for long storage in that contents are less perishable. However, in the case where gas barrier properties are not sufficient, oxygen will enter a container during the storage, and which causes deterioration and degradation of contents. Therefore, in a packaging bag for a boiling/retorting treatment, how permeation of oxygen, etc. can be suppressed will be a major factor that determines the worth of the packaging bag.

Conventionally, with respect to packages used for such packaging applications for food and medicine, various methods for providing gas barrier layers in order to block gases such as oxygen and water vapor have been devised. Metals (for example, see Patent Document 1) and metal oxides (for example, see Patent Document 2), which are laminated by a printing substrate film, etc. in accordance with a vapor deposition method, have been used particularly as a material having high gas barrier properties. And in the above-mentioned packaging bag for a boiling/retorting treatment as well, a retort packaging bag formed by laminating an aluminum vapor deposited film or a foil of aluminum itself is a mainstream for long storage. However, the composite laminate film using such materials is generally expensive. In addition, there remain problems that it cannot be employed in the fields requiring transparency or be aptly applied to heating with a microwave oven.

Then, under consideration is the application of the gas barrier coating agent (for example, see Patent Document 3), which has been developed recently, containing: highly crystalline resins such as polyvinyl alcohol and ethylene-vinyl alcohol; and inorganic layered compounds such as montmorillonite, for example.

In the gas barrier layer obtained from such a coating agent, it is necessary to increase a content of an inorganic layered compound in order to obtain gas barrier properties corresponding to those of an aluminum foil and a vapor deposited film. An increase in the content of the inorganic layered compound in the gas barrier layer, however, involves a reduction in hydrothermal resistance of the gas barrier layer itself and a simultaneous decrease in the adhesion to a base film. Therefore, the packaging bag for a boiling/retorting treatment simply provided with such a gas barrier layer has a problem of low hydrothermal processability.
Patent Document No. 1: Japanese Kokai Publication Hei-08-318591
Patent Document No. 2: Japanese Kokai Publication Sho-62-179935
Patent Document No. 3: Japanese Kokai Publication Hei-07-276576

### SUMMARY OF THE INVENTION

The present invention has been made in view of the situation. That is, it is a problem to be solved by the present invention to provide: a gas barrier composite film that has a favorable adhesion between a gas barrier layer and other layers even in the case of using a coating agent improved in gas barrier properties to form a composite laminate film by increasing an amount of an inorganic layered compound and which has hydrothermal processability upon forming it into a packaging bag; and a packaging bag obtained by using the same.

The present inventors made earnest investigations in order to solve the above-mentioned problem, and consequently found that the problem can be solved by providing an adhesive layer formed by applying an adhesive composition that contains at a specific ratio: a base material mainly comprising a polyurethane resin having at least one functional group selected from the group consisting of an amino group, a hydroxyl group, and a carboxyl group; and a curing agent comprising an isocyanate curing agent and an epoxy curing agent. These findings have now led to completion of the present invention.

That is, the present invention relates to (1) a gas barrier composite film for a hydrothermally processable package,

wherein at least one gas barrier layer comprising a gas barrier resin and an inorganic layered compound is interposed between a base film layer and a sealing material layer, and

an adhesive layer is further formed on both sides of the gas barrier layer by applying an adhesive composition comprising: a base material mainly comprising a polyurethane resin having at least one functional group selected from the group consisting of an amino group, a hydroxyl group, and a carboxyl group; and a curing agent comprising an isocyanate curing agent and an epoxy curing agent, at the following functional group ratio:

I/P=0.3 to 30.0

E/P=1.5 to 25.0

(here, “P” represents the total number of moles of primary and secondary amino groups, hydroxyl groups, and carboxyl groups contained in the base material, “I” represents the number of moles of isocyanate groups contained in the isocyanate curing agent, and “E” represents the number of moles of epoxy groups contained in the epoxy curing agent).

The present invention also relates to (2) the gas barrier composite film for a hydrothermally processable package according to (1), wherein the polyurethane resin has a weight-average molecular weight of 5000 to 200000.

The present invention also relates to (3) the gas barrier composite film for a hydrothermally processable package according to (1) or (2), wherein the gas barrier layer comprises the gas barrier resin and the inorganic layered compound in a mass ratio in the range of (30/70) to (70/30).

The present invention also relates to (4) the gas barrier composite film for a hydrothermally processable package according to any one of (1) to (3), wherein the gas barrier resin is at least one selected from the group consisting of a polyvinyl alcohol copolymer and an ethylene-vinyl alcohol copolymer.

The present invention also relates to (5) the gas barrier composite film for a hydrothermally processable package according to any one of (1) to (4), further comprising a printed layer interposed between the base film layer and the sealing material layer.

The present invention also relates to (6) a packaging bag, which is obtained by forming into a bag the gas barrier composite film for a hydrothermally processable package according to any one of (1) to (5).

### DETAILED DESCRIPTION OF THE INVENTION

Hereinafter, the gas barrier composite film for a hydrothermally processable package according to the present invention and a packaging bag according to the present invention obtained by forming it into a bag will be described in detail.

First, the gas barrier composite film for a hydrothermally processable package of the present invention will be described.

The gas barrier composite film for a hydrothermally processable package of the present invention is a composite film formed by laminating: at least one gas barrier layer between a base film layer and a sealing material layer; an adhesive layer provided on both sides of the gas barrier layer; and a printed layer as needed.

The base film layer will be described in the first place.

Examples of the base film layer include: various plastic films comprising polyolefin, modified polyolefin, polyester, nylon, polystyrene, and the like, which are conventionally used for flexible packaging; and composite films comprising two or more of these. These films are preferably subjected to corona discharge treatment or surface coating treatment. The polyolefin film is preferable in terms of gas barrier properties.

Next, the sealing material layer will be described.

The sealing material layer is made of, for example, a sealing material having thermal adhesiveness conventionally used for flexible packaging, and examples thereof include a polyethylene film, a polypropylene film, and the like. In addition, the sealing material layer may be a layer formed by: laminating, in a molten state, hot-melt polymers such as low-density polyethylene, an ethylene-vinyl acetate copolymer, and a polypropylene polymer; and cooling the resulting polymers to be molded into a film. In this case, since an adhesive layer cannot be preliminarily provided on the base film layer, there is employed a method for laminating the hot-melt polymers in a molten state after providing the adhesive layer on the gas barrier layer side.

Subsequently, the gas barrier layer will be described.

The gas barrier layer is formed by using a gas barrier resin and an inorganic layered compound. In general, containing the materials in a solvent to obtain a gas barrier coating agent composition, the gas barrier layer can be formed by using various coating means.

Here, usable as the gas barrier resin are one or more selected from the group consisting of: a polyvinyl alcohol copolymer (PVA) and an ethylene-vinyl alcohol copolymer (EVOH), which are highly crystalline resins; and gas barrier resins, such as a polyacrylonitrile-based resin, a polyamide-based resin, a polyester-based resin, a polyurethane-based resin, and a polyacrylic resin.

The gas barrier resin preferably has an oxygen permeability of 100 (cm³/m²·day·kPa) or less at a room temperature (23° C.) when a thickness of the resin layer is set to 10 μm.

Here, the “oxygen permeability of 100 (cm³/m²·day·kPa) or less when a thickness of the resin layer is set to 10 μm” means that the value was 100 (cm³/m²·day·kPa) or less when measured according to JIS K 7126 method B using an oxygen transmission rate test system (“OX-TRAN 100”, produced by Mocon Inc.) in an atmosphere of 23° C. and 0% RH (relative humidity).

Among others, from viewpoints of high gas barrier properties to be obtained, an adhesion to an adhesive layer to be described later, and the like, a polyvinyl alcohol copolymer or an ethylene-vinyl alcohol copolymer can be preferably used, and an ethylene-vinyl alcohol copolymer resin can be particularly preferably used.

The polyvinyl alcohol polymer that can be used in the present invention may be any of polyvinyl alcohol, and its derivatives and alternations. These may be used singly or two or more of them may be used in combination. With respect to the polyvinyl alcohol polymer, a polymerization degree thereof is preferably 100 to 5000, and more preferably 500 to 3000, and a saponification degree thereof is preferably 60 mol % or more, and more preferably 75 mol % or more. Examples of the polyvinyl alcohol derivatives include polyvinyl alcohol derivatives in which about 40 mol % of the hydroxyl group is acetalized, and the like. Examples of the polyvinyl alcohol alternations include: polyvinyl alcohol alternations obtained by copolymerizing a carboxyl group-containing monomer, an amino group-containing monomer, etc.; and the like.

Here, the polyvinyl alcohol polymer has an advantage of showing very high gas barrier properties in a dry condition; on the other hand, the degree of reduction in gas barrier properties of the polyvinyl alcohol polymer under high humidity is larger than that of the ethylene-vinyl alcohol copolymer; thus, upon use of the polyvinyl alcohol polymer under high humidity, it is preferable to increase a content of an inorganic layered compound to be described below, in a gas barrier coating agent composition.

As the ethylene-vinyl alcohol copolymer that can be used in the present invention, a copolymer obtained by saponifying an ethylene-vinyl acetate copolymer can be employed.

Examples of the copolymer obtained by saponifying an ethylene-vinyl acetate copolymer include: a copolymer that is obtained by saponifying an ethylene-vinyl acetate copolymer obtained by copolymerizing ethylene and vinyl acetate; and a copolymer that is obtained by saponifying an ethylene-vinyl acetate copolymer obtained by copolymerizing other monomers as well as ethylene and vinyl acetate.

As a material for providing a gas barrier layer, the percentage of ethylene in all the monomers before copolymerizing to provide the ethylene-vinyl acetate copolymer is preferably 20 to 60 mol %. The percentage of etylene less than 20 mol % tends to reduce gas barrier properties under high humidity; whereas the percentage of etylene exceeding 60 mol % tends to decrease gas barrier properties on the whole. In addition, the ethylene-vinyl acetate copolymer preferably has a saponification degree of 95 mol % or more. The saponification degree of vinyl acetate less than 95 mol % tends to cause insufficient gas barrier properties and oil resistance.

The ethylene-vinyl acetate copolymer is preferable in that when it is treated to have a lower molecular weight by using peroxides and the like, the stability of the dissolved copolymer in a solvent is favorable.

As other characteristic values of the ethylene-vinyl acetate copolymer, it is preferable to have the respective values described in claims of Japanese Kokai Publication Hei-05-295119. The ethylene-vinyl acetate copolymer having the characteristic values is a preferable gas barrier resin in that it can be more easily dissolved in the below-described mixed solvent of water and alcohols such as methanol, ethanol, and propanol to prepare a gas barrier coating agent.

The inorganic layered compound, the other material of the gas barrier coating agent composition that forms a gas barrier layer, will be described.

Utilizable as the inorganic layered compound are inorganic layered compounds capable of swelling and cleaving in a solvent. Examples thereof include: kaolinite group ones having a 1:1 phyllosilicate structure; antigorite group ones belonging to the serpentine family; smectite group ones according to the number of interlaminar cations; vermiculite group ones (hydrous silicate minerals); and mica group ones; and the like.

As specific examples of the inorganic layered compound, there are preferably used kaolinite, nacrite, dickite, halloysite, hydrated halloysite, antigorite, chrysotile, pyrophyllite, montmorillonite, beidellite, saponite, hectorite, sauconite, stevensite, tetrasilic mica, sodium taeniolite, muscovite, margarite, talc, vermiculite, phlogopite, xanthophyllite, chlorite, and the like. These may be natural products or synthetic products. Scaly silica and the like can also be used. These may be used singly or two or more of them may be used in combination.

Montmorillonite is preferably employed among these in view of easy availability and high cleavage, and the favorable gas-barrier property and coating suitability attainable by using the same in the coating agent composition.

The solvent used for dispersing a material forming the gas barrier layer to obtain a gas barrier coating agent composition will be described.

Any of an aqueous solvent, a nonaqueous solvent, and a mixed solvent of these can be used as such a solvent as long as employed to dissolve or disperse a material for obtaining the gas barrier layer and allowed to dissolve the gas barrier resin. The solvent is preferably an aqueous solvent or a mixed solvent of water and an organic solvent to specifically meet environmental needs. Examples of the mixed solvent include a mixed solvent composed of water, and a water-miscible organic solvent, such as: alcohols such as methanol, ethanol, and propanol; polyhydric alcohols such as ethylene glycol and propylene glycol or an alkyl ether derivative thereof; esters such as ethyl formate, methyl acetate, and ethyl acetate; and ketones such as acetone.

In the gas barrier coating composition, there may be added according to need one or more of such additives as leveling agents, antifoaming agents, antiblocking agents such as waxes and silica, mold release agents such as metal soaps and amides, ultraviolet absorbers, antistatic agents, and coloring agents.

Using the above-mentioned material, it is possible to prepare a gas barrier coating composition and apply the resultant composition with a known coating method, consequently to form a gas barrier layer.

Here, the usage of the gas barrier resin and the inorganic layered compound is preferably in a mass ratio of the gas barrier resin/the inorganic layered compound in the range of (30/70) to (70/30), and more preferably in the range of (30/70) to (50/50). With respect to the gas barrier coating agent composition, specifically, a gas barrier resin is more preferably an ethylene-vinyl alcohol copolymer, and the gas barrier layer more preferably contains the ethylene-vinyl alcohol copolymer and the inorganic layered compound in a mass ratio in the range of (30/70) to (70/30).

If the mass ratio of the inorganic layered compound decreases, the gas barrier layer to be obtained tends to have a higher adhesion to a substrate but show lower gas barrier properties. In contrast to this, if the mass ratio of an inorganic layered compound increases, the gas barrier layer to be obtained tends to have higher gas barrier properties but show a lower adhesion to a substrate, lower strength of the coat itself, and reduced hydrothermal processability. Here, the mass ratio refers to a mass ratio converted into a solid content.

As a total amount, 1 to 30% by mass of the gas barrier resin and the inorganic layered compound are preferably contained in the gas barrier coating agent composition. The total amount less than 1% by mass may cause disadvantages such as necessary multiple coatings for the formation of the gas barrier layer having a proper thickness; whereas the total amount of more than 30% by mass may cause disadvantages such as a difficulty in coating caused by reduced fluidity.

Examples of a method for producing the gas barrier coating agent composition using the above-mentioned constituent material include: (a) a method comprising adding and mixing inorganic layered compounds (which may preliminary swell and be cleaved in a dispersing solvent such as water) in a solution in which a gas barrier resin was preliminarily dissolved in the solvent, and further cleaving and dispersing the inorganic layered compounds in the obtained mixed liquid with use of a stirring apparatus and a dispersing apparatus; (b) a method comprising swelling and cleaving inorganic layered compounds in a dispersing solvent such as water, further swelling and cleaving them with use of a stirring apparatus or a dispersing apparatus to form a dispersion, and thereafter adding and mixing a solution, in which a gas barrier resin was preliminarily dissolved in the solvent, to the dispersion.

As stirring apparatuses and dispersing apparatuses, it is possible to uniformly disperse inorganic layered compounds in a dispersion using conventional stirring apparatuses and dispersing apparatuses. However, it is preferable to use a high-pressure dispersing apparatus, an ultrasonic dispersing apparatus, or the like so as to obtain a transparent and stable inorganic layered compound dispersion.

Examples of the high-pressure dispersing apparatus include Nanomizer (trade name, produced by Nanomizer Inc.), Microfluidizer (trade name, produced by Microfluidics), Ultimaizer (trade name, produced by Sugino Machine Limited), DeBee (trade name, produced by B.e.e. International Ltd.), Niro Soavi homogenizer (trade name, produced by Niro Soavi S.p.A.), and the like. It is preferable to carry out a dispersion treatment at 100 MPa or less as a pressure condition of these high-pressure dispersing apparatuses. If the pressure condition exceeds 100 MPa, the inorganic layered compound is more likely to be ground, and the intended gas barrier property may be deteriorated.

Subsequently, the following description will discuss the adhesive layer.

The adhesive layer is formed by preparing an adhesi ve composition comprising a base material mainly comprising a polyurethane resin having at least one functional group selected from the group consisting of an amino group, a hydroxyl group, and a carboxyl group, and a curing agent comprising an isocyanate curing agent and an epoxy curing agent in a solvent, and applying the resultant adhesive composition by employing various coating means.

The constituent materials contained in the adhesive composition for forming the adhesive layer will be described hereinafter.

As a polyurethane resin employed as a main component of the base material for forming the adhesive layer, it is possible to use a polyurethane resin having at least one functional group selected from the group consisting of an amino group, a hydroxyl group, and a carboxyl group in the molecule. A molecular weight of the polyurethane resin is preferably a weight-average molecular weight of 5000 to 200000. The weight-average molecular weight less than 5000 may cause reduction in both adhesion and hydrothermal processability; whereas the weight-average molecular weight exceeding 200000 may cause a higher composition viscosity and a reduced coating property.

The weight-average molecular weight can be measured by the column chromatography method. As an example, the measurement can be performed by using Water 2690 (produced by Waters Corporation) and PLgel 5 μ MIXED-D (produced by Polymer Laboratories Ltd.) to obtain a weight-average molecular weight on polystyrene conversion.

Examples of the polyurethane resin include a polyurethane resin having at least one functional group selected from the group consisting of a hydroxyl group, an amino group, and a carboxyl group in the molecule. The polyurethane resin is obtained by using a method comprising: prepareing a urethane prepolymer which has the isocyanate group in a molecular terminal and are obtained by reacting a polymeric polyol and an organic diisocyanate, chain-extending the prepolymer with a chain extender, and reacting the resultant urethan prepolymer with a reaction terminator, if necessary.

Conventionally known ones can be used as the organic diisocyanate, the polymeric polyol, the chain extender, the reaction terminator, etc., and it is possible to use the respective compounds described in, for example, Japanese Kokai Publication Hei-06-136313; Japanese Kokai Publication Hei-06-248051; Japanese Kokai Publication Hei-07-258357; and Japanese Kokai Publication Hei-07-324179. The conditions described in the Japanese Kokai Publications can be used as conditions such as temperature in a method for synthesizing a polyurethane resin having at least one functional group selected from the group consisting of a hydroxyl group, an amino group, and a carboxyl group in the molecule.

In order to obtain the polyurethane resin having at least one functional group selected from the group consisting of a hydroxyl group, an amino group, and a carboxyl group in the molecule, upon the reaction between the polymeric polyol and the organic diisocyanate, there may be employed: as a chain extender, diol monoalkyl carboxylic acids such as dimethylol propionic acid; aromatic carboxylic acid-containing polyols obtained by reacting aromatic carboxylic acids such as phthalic acid, pyromellitic acid, trimellitic acid, and their anhydrides, with low polyols; and aminoalkylethanolamines such as aminoethylethanolamine: monoethanolamine and n-butylamine as a reaction terminator: diamine as a chain extender and a reaction terminator: and the like. Thereby, it is possible to introduce at least one functional group selected from the group consisting of a hydroxyl group, an amino group, and a carboxyl group in the molecule.

Unless lowering the performance of the base material, it is possible to use in combination a polyester-based resin, an acrylic-based resin, a urethane-based resin, and an epoxy-based resin, as additional components to the base material.

The curing agent comprising an isocyanate curing agent and an epoxy curing agent, which are contained in an adhesive composition for forming the adhesive layer, will be described.

As an isocyanate curing agent, it is possible to use a polyisocyanate curing agent, a component of conventionally known two-component adhesives, used for producing a composite laminate film for packaging. Examples of the isocyanate curing agent include polyisocyanates, such as: an adduct type obtained by reacting 1 mol of trimethylolpropane and 3 mol of diisocyanate; a biuret type obtained by reacting 3 mol of diisocyanate and 1 mol of water; an isocyanurate type obtained by polymerizing 3 mol of diisocyanate, and the like. Examples of the diisocyanate include tolylene diisocyanate, 4,4-diphenylmethane diisocyanate, hexamethylene diisocyanate, isophorone diisocyanate, xylylene diisocyanate, and the like. These may be used singly or two or more of them may be used in combination.

As an epoxy curing agent, it is possible to use an epoxy curing agent, a component of conventionally known two-component adhesives, used for producing a composite laminate film for packaging. Examples thereof include: Celloxide 2000, 2021, 2081, and 3000, and Epolead GT-301, GT-401, and PB-3600, and the like, sold by the Daicel Chemical Industries, Ltd.; a low-chlorine polyfunctional aliphatic epoxy compound (Denacol EX-L series), sold by Nagase ChemteX Corporation; and the like.

The solvent of the adhesive composition that makes a coating means available by dissolving or dispersing the material forming the adhesive layer will be described.

Examples of such solvents include aromatic solvents such as benzene, toluene, and xylene; alcohol solvents such as methanol, ethanol, isopropyl alcohol, and n-butanol; ketone solvents such as acetone, methyl ethyl ketone, and methyl isobutyl ketone; ester solvents such as ethyl acetate, butyl acetate, and propyl acetate; ethers such as tetrahydrofuran; polyhydric alcohol derivatives such as ethylene glycol monomethyl ether and ethylene glycol monoethyl ether; and the like. These may be used singly or two or more of them may be used in combination. As a mixed solvent of an aqueous solvent and an organic solvent, utilizable is a mixed solvent of: water; and an organic solvent having miscibility with water out of the alcohol solvents, the ketone solvents, the ester solvents, and the polyhydric alcohol derivatives.

And the base material, the isocyanate curing agent, and the epoxy curing agent may be separately dissolved or dispersed, and then mixed immediately before applying an adhesive composition, or the base material, the isocyanate curing agent, and the epoxy curing agent may be dissolved or dispersed at one time in a solvent immediately before forming an adhesive composition. Here, as a solvent of the isocyanate curing agent or the epoxy curing agent, it is preferable to use a solvent without any functional group reactable with those curing agents.

In addition, when these curing agents are dissolved or dispersed in separate solvents and one solvent system has a functional group reactable with other curing agent systems, it is preferable to mix and use these curing agents immediately before applying the adhesive composition.

In the adhesive composition for forming an adhesive layer, a content ratio of the constituent material satisfies the following equation.

I/P=0.3 to 30.0, preferably 0.5 to 10.0

E/P=1.5 to 25.0

(here, “P” represents the total number of moles of primary and secondary amino groups, hydroxyl groups, and carboxyl groups contained in the base material, “I” represents the number of moles of isocyanate groups contained in the isocyanate curing agent, and “E” represents the number of moles of epoxy groups contained in the epoxy curing agent).

The value “P” can be found by calculating the product of: the total number of moles of amino groups, hydroxyl groups, and carboxyl groups per unit weight obtained by an acid value, a hydroxyl value, and an amine value; and the amount of the base material. The acid value and the hydroxyl value can be determined in accordance with the JIS K 0070 method; and the amine value, according to the JIS K 2501 method.

The value “I” can be found by calculating the product of: the number of moles of isocyanate groups per unit weight obtained by an isocyanate value; and the amount of the isocyanate curing agent. The isocyanate value can be determined in accordance with the Siggia-Hanna method.

The value “E” can be found by calculating the value of the blending amount/epoxy equivalent of the epoxy curing agent based on the value of the epoxy equivalent of the epoxy curing agent obtainable according to the JIS K 7236 method.

If the amount of the isocyanate curing agent and the epoxy curing agent is less than the range of the above-mentioned equations, the effects as a curing agent are not observed and the adhesion and hydrothermal resistance to other layers remain low. On the other hand, if the amount is large, since the effects level off and cause economical disadvantages, that is not preferable.

Finally, the amount is adjusted so as to give a ratio of the material in the solvent within the above-mentioned suitable range and an adhesive composition can be obtained by dispersing the material with use of a high-speed stirrer, etc.

Next, the printed layer will be described.

In order to form the printed layer for the functions of contents indication and decoration, it is possible to typically use conventionally known organic solvent printing ink compositions, water-based printing ink compositions, etc. with a gravure printing technique and a flexographic printing technique.

Examples of the organic solvent printing ink composition include, in addition to aromatic and non-aromatic mixing organic solvent printing ink compositions containing a pigment and a polyurethane resin, organic solvent printing ink compositions disclosed in Japanese Kokai Publication Hei-01-261476 (aromatic and non-aromatic mixing organic solvent printing ink compositions containing a pigment, a polyurethane resin, chlorinated polypropylene), Japanese Kohyo Publication Hei-07-113098 (non-aromatic organic solvent printing ink compositions containing a pigment and a polyurethane resin), Japanese Kokai Publication Hei-07-324179 (non-aromatic and non-ketone organic solvents containing a pigment, a polyurethane resin, and a printing ink composition), etc.; and the like.

Examples of the water-based printing ink composition include water-based printing ink compositions disclosed in Japanese Kokai Publication Hei-06-155694 (water-based printing ink compositions containing a pigment, an acrylic water-based binder resin, a hydrazine crosslinking agent), Japanese Kokai Publication Hei-06-206972 (water-based printing ink compositions containing a pigment, water, a polyurethane binder resin), etc.; and the like.

Moreover, as an environmentally friendly ink, there are nowadays employed a water-based printing ink composition, and a printing ink composition that belongs to an organic solvent printing ink composition but consumes as less aromatic and ketone organic solvents as possible. The gas barrier composite film of the present invention also allows for suitable applications of these printing ink compositions.

Furthermore, the gas barrier composite film for a hydrothermally processable package of the present invention may have other functional layers such as an ultraviolet shielding layer, an antibacterial layer, and an adhesive layer for adhering layers toghther excluding the gas barrier layer.

The method for producing a gas barrier composite film using the above-mentioned material may be any method as long as the method entails high gas barrier properties, hydrothermal processability, and if necessary the functions of decoration and contents indication given by printing. For example, there may be mentioned the following methods (A) to (D), etc.

As the most basic configuration, there may be mentioned;

(A) a method for producing a gas barrier composite film for a hydrothermally processable package by sequentially applying the adhesive composition, the gas barrier coating agent composition, and the adhesive composition on a base film (including a composite film), and thereafter laminating a sealing material layer thereon.

As the configulation including a printed layer, there may be mentioned;

(B) a method for producing a gas barrier composite film for a hydrothermally processable package by printing an ink composition on a base film to form a printed layer, then sequentially coating on the resultant printed layer the adhesive composition, the gas barrier coating agent composition, and the adhesive composition, and thereafter laminating a sealing material layer thereon;
(C) a method for producing a gas barrier composite film for a hydrothermally processable package by sequentially coating on a base film the adhesive composition, the gas barrier coating agent composition, and the adhesive composition, printing an ink composition to form a printed layer, and thereafter laminating a sealing material layer thereon;
(D) a method for producing a gas barrier composite film for a hydrothermally processable package by sequentially coating and laminating the adhesive (agent) layer-gas barrier layer-adhesive (agent) layer on both a base film side and a sealing material side across the intermediate printed layer in the same manner as in the above-mentioned means; and the like.

Here, examples of the method for applying the adhesive composition and the gas barrier coating agent composition include: a roll coating method, a doctor knife method, and an air knife/nozzle coating method, with use of a conventional gravure cylinder, etc.; a bar coating method; a spray coating method; a dip coating method; and a combined coating method of these.

In addition, a gravure printing method and a flexographic printing method can be generally employed in order to form a printed layer.

In the gas barrier composite film for a hydrothermally processable package obtained from the above-mentioned methods, the adhesive layer preferably has a thickness of 2 to 3 μm. The gas barrier layer preferably has a thickness of 0.1 to 5 μm, and the thickness to form a more transparent gas barrier layer is preferably in the range of 0.1 to 0.5 μm.

If the thickness of the adhesive layer is less than 2 μm, it may reduce the adhesion between a base film layer and a gas barrier layer; meanwhile, when the thickness is more than 3 μm, an increase in adhesion corresponding to an increase in thickness is not observed, and a favorable handling property may not be obtained upon use of a gas barrier composite film as a packaging bag. Moreover, a gas barrier layer less than 0.1 μm makes it difficult to obtain high gas barrier properties; on the other hand, a gas barrier layer exceeding 5 μm does not lead to a marked improvement in gas barrier properties and tends to make it difficult to obtain a transparent coat. Here, when a coat having a thickness within the range is not obtained with one coating, it is also possible to perform multiple coatings.

Upon providing other functional layers, it is possible to produce a gas barrier composite film for a hydrothermally processable package suited to an object by combining favorable means for providing the respective functional layers and the above-mentioned methods (A) to (D).

By the use of a heat sealer, etc., the gas barrier composite film for a hydrothermally processable package obtained from the above-mentioned materials and manufacturing methods may be folded inwardly to heat seal two sides, or two gas barrier composite films for a hydrothermally processable package obtained therefrom may be superposed on each other for heat sealing three sides, so as to form a bag in each case. The resultant bag may be packed with contents and the other side may be heat sealed so as to enable use as a sealed packaging bag. Such an embodiment is one of the preferable embodiments of the present invention.

And the obtained packaging bag can be used as a packaging bag of food or medical supplies.

### EFFECT OF THE INVENTION

The gas barrier composite film of the present invention has excellent lamination properties, heat-sealing properties, gas barrier properties, and transparency, and furthermore has a favorable adhesion between a gas barrier layer and other layers. Moreover, the packaging bag obtained by using this gas barrier composite film has excellent hydrothermal processability.

### BEST MODE FOR CARRYING OUT THE INVENTION

The following Examples illustrate the present invention in further detail. These are, however, by no means limitative of the scope of the invention unless the mode of practice deviates from the spirit and application range thereof. Although an ethylene-vinyl alcohol copolymer is especially used as a gas barrier resin in the Examples, the effects of the present invention also can be obtained upon using a polyvinyl alcohol polymer. In the following description, “%” means “% by mass” and “part(s)” means “part(s) by mass”.

### <Gas Barrier Coating Agent>

### <Gas Barrier Coating Agent Composition 1> (EVOH/Inorganic Layered Compound=4/6 (Solid Content Mass Ratio))

To 60 parts of a mixed solvent composed of 50% of purified water and 50% of isopropyl alcohol (IPA) was added 30 parts of EVOH (trade name: “SoarnoL(R) D-2908”, produced by Nippon Synthetic Chemical Industry Co., Ltd.), followed by further addition of 10 parts of a 30% aqueous solution of hydrogen peroxide. The mixture was heated to 80° C. with stirring and the reaction was allowed to proceed for about two hours. Then, after cooling, catalase was added to a concentration of 3000 ppm to thereby eliminate the residual hydrogen peroxide. In this manner, an almost transparent resin solution with a solid content of 30% was obtained.

In addition, 5 parts of the inorganic layered compound montmorillonite (trade name: “Kunipia F”, produced by Kunimine Industries Co., Ltd.) was added to 95 parts of purified water with stirring and sufficiently stirred for effecting dispersion using a high-speed stirrer.

Thereafter, the mixture was kept at 40° C. for one day. An inorganic layered compound dispersion with a solid content of 5% was thus obtained.

An amount of 4 parts of the resin solution was added to 60 parts of a mixed solvent composed of 50% of purified water and 50% of IPA, followed by stirring for thorough blending. Furthermore, 36 parts of the inorganic layered compound dispersion was added to the above solution with stirring at a high speed, and the resulting mixture was subjected to dispersion treatment at a pressure set at 50 MPa in a high-pressure dispersing device and thereafter filtrated with a filter having a fineness of 255 meshes, and a gas barrier coating agent composition 1 with a solid content of 3% (EVOH/inorganic layered compound=4/6 (solid content mass ratio) was obtained.

### <Gas Barrier Coating Agent Composition 2> (EVOH/Inorganic Layered Compound=5/5 (Solid Content Mass Ratio))

To 65 parts of a mixed solvent composed of 50% of purified water and 50% of IPA was added 5 parts of the resin solution, which is the same as that used in preparing the gas barrier coating agent composition 1, followed by stirring for thorough blending. Furthermore, 30 parts of the inorganic layered compound dispersion, identical to that used in preparing the gas barrier coating agent composition 1, was added to the above solution with stirring at a high speed, and the resulting mixture was subjected to dispersion treatment at a pressure set at 50 MPa in a high-pressure dispersing device and thereafter filtrated with a filter having a fineness of 255 meshes, and a gas barrier coating agent composition 2 with a solid content 3% (EVOH/inorganic layered compound =5/5) was obtained.

### <Gas Barrier Coating Agent Composition 3> (EVOH/Inorganic Layered Compound=6/4 (Solid Content Mass Ratio))

To 70 parts of a mixed solvent composed of 50% of purified water and 50% of IPA was added 6 parts of the resin solution, which is the same as that used in preparing the gas barrier coating agent composition 1, followed by stirring for thorough blending. Furthermore, 240 parts of the inorganic layered compound dispersion, identical to that used in preparing the gas barrier coating agent composition 1, was added to the above solution with stirring at a high speed, and the resulting mixture was subjected to dispersion treatment at a pressure set at 50 MPa in a high-pressure dispersing device and thereafter filtrated with a filter having a fineness of 255 meshes, and a gas barrier coating agent composition 3 with a solid content 3% (EVOH/inorganic layered compound =6/4) was obtained.

### <Adhesive Composition>

### Base Material

### <Polyurethane Resin 1>

A four-necked flask equipped with a reflux condenser, nitrogen gas inlet tube, stirring rod and thermometer was charged with 220 parts by mass of poly(3-methyl-1,5-pentanediol adipate)diol having a molecular weight of 2000, 48.8 parts by mass of isophorone diisocyanate, and 0.03 parts by mass of tetrabutyl titanate. The resultant mixture was retained at about 80° C for two hours to react the isocyanate group and the hydroxyl group. This reactant was cooled to 65° C., 467.5 parts by mass of ethyl acetate and 198.7 parts by mass of isopropanol were added and diluted, 14.0 parts by mass of isophorone diamine was added for chain extension, and subsequently 3.3 parts by mass of monoethanolamine was added for performing a terminated reaction, to obtain a polyurethane resin solution 1 with a solid content of 30% and a weight-average molecular weight of 18000.

### <Polyurethane Resin 2>

A four-necked flask equipped with a reflux condenser, nitrogen gas inlet tube, stirring rod and thermometer was charged with 240 parts by mass of poly(3-methyl-1,5-pentanediol adipate)diol having a molecular weight of 2000, 48.6 parts by mass of isophorone diisocyanate, and 0.03 parts by mass of tetrabutyl titanate. The resultant mixture was retained at about 80° C. for two hours to react the isocyanate group and the hydroxyl group. This reactant was cooled to 65° C., 488.6 parts by mass of ethyl acetate and 209.4 parts by mass of isopropanol were added and diluted, 7.1 parts by mass of aminoethylethanolamine was added for chain extension, and subsequently the residual isocyanate group was reacted with 3.7 parts by mass of monoethanolamine, to obtain a polyurethane resin 2 with a solid content of 30% and a weight-average molecular weight of 40800.

### (Curing Agent)

The following commercial products were used as isocyanate curing agents and epoxy curing agents used for curing agents.

### <Isocyanate Curing Agent>

R curing agent (solid content 40%, produced by Sakata Inx Corp.)

### <Epoxy Curing Agent>

Celloxide 2021 (solid content 30%, produced by Daicel Chemical Industries, Ltd.)

### <Adhesive Composition>

Adhesive compositions 1 to 6 were obtained by mixing each component in the constitution shown in Table 1.

TABLE 1
Adhesive composition

| | Adhesive composition No. | | | | | |
|---|---|---|---|---|---|---|
| | 1 | 2 | 3 | 4 | 5 | 6 |
| Polyurethane resin 1 (solid content 30%) (parts by mass) | 29.6 | 29.6 | 29.6 | — | 29.6 | 29.6 |
| Polyurethane resin 2 (solid content 30%) (parts by mass) | — | — | — | 29.6 | — | — |
| Isocyanate curing agent (solid content 40%) (parts by mass) | 2.8 | 2.8 | 2.8 | 2.8 | 2.8 | 2.8 |
| Epoxy curing agent (solid content 100%) (parts by mass) | 0.45 | 0.9 | 1.8 | 0.9 | 0.09 | 4.5 |
| Ethyl acetate (parts by mass) | 67.15 | 66.7 | 66.0 | 66.7 | 67.51 | 63.1 |
| Total (parts by mass) | 100.0 | 100.0 | 100.0 | 100.0 | 100.0 | 100.0 |
| I/P | 4.6 | 4.6 | 4.6 | 2.9 | 4.6 | 4.6 |
| E/P | 3.4 | 6.8 | 13.6 | 4.2 | 0.68 | 34.0 |

### (Printing Ink Composition)

An amount of 200 parts by mass of poly(3-methyl-1,5-pentane adipate)diol having an average molecular weight of 2000, 44.4 parts by mass of isophorone diisocyanate, 13.6 parts by mass of isophorone diamine, and 2.44 parts by mass of monoethanolamine were reacted by a conventional method to obtain a urethane-based binder resin solution (a solution with a solid content of 30%, solvent composition: methylethyl ketone/isopropanol=72/28). An amount of 30 parts by mass of this urethane-based binder resin, 30 parts by mass of titanium oxide, 6.9 parts by mass of ethyl acetate, and 33.1 parts by mass of isopropyl alcohol were mixed and kneaded to obtain an organic solvent printing ink for lamination.

### EXAMPLES 1 TO 3

An adhesive composition 2 was applied to a corona-treated surface of a corona-treated polypropylene film (trade name: “Pylen P-2161”, produced by Toyobo Co., Ltd., thickness 25 μm), and after being dried, gas barrier coating agent compositions 1 to 3 were applied thereon and dried to form a gas barrier layer with thickness of 0.3 μm. Using the adhesive composition 2, an unstretched polypropylene film was laminated on the obtained gas barrier layer with a dry lamination machine and subjected to aging at 40° C. for three days to obtain gas barrier composite films for a hydrothermally processable package according to Examples 1 to 3.

### EXAMPLE 4

An adhesive composition 1 was applied to a corona-treated surface of a corona-treated polypropylene film (produced by a Toyobo Co., Ltd., trade name: “Pylen P-2161”, thickness 25 μm), and after being dried, a gas barrier coating agent composition 2 was applied thereon and dried to form a gas barrier layer with thickness of 0.3 μm. Using the adhesive composition 1, an unstretched polypropylene film was laminated on the obtained gas barrier layer with a dry lamination machine and subjected to aging at 40° C. for three days to obtain a gas barrier composite film for a hydrothermally processable package according to Example 4.

### EXAMPLE 5

An adhesive composition 3 was applied to a corona-treated surface of a corona-treated polypropylene film (produced by a Toyobo Co., Ltd., trade name: “Pylen P-2161”, thickness: 25 μm), and after being dried, a gas barrier coating agent composition 2 was applied thereon and dried to form a gas barrier layer with thickness of 0.3 μm. Using the adhesive composition 3, an unstretched polypropylene film was laminated on the obtained gas barrier layer with a dry lamination machine and subjected to aging at 40° C. for three days to obtain a gas barrier composite film for a hydrothermally processable package according to Example 5.

### EXAMPLE 6

An adhesive composition 4 was applied to a corona-treated surface of a corona-treated polypropylene film (produced by a Toyobo Co., Ltd., trade name: “Pylen P-2161”, thickness: 25 μm), and after being dried, a gas barrier coating agent composition 2 was applied thereon and dried to form a gas barrier layer with thickness of 0.3 μm. Using the adhesive composition 4, an unstretched polypropylene film was laminated on the obtained gas barrier layer with a dry lamination machine and subjected to aging at 40° C. for three days to obtain a gas barrier composite film for a hydrothermally processable package according to Example 6.

### EXAMPLE 7

The printing ink for lamination was printed on a corona-treated surface of a corona-treated polypropylene film (produced by a Toyobo Co., Ltd., trade name: “Pylen P-2161”, thickness: 25 μm), and then an adhesive composition 2 was applied thereon to, and after being dried, a gas barrier coating agent composition 2 was applied thereon and dried to form a gas barrier layer with thickness of 0.3 μm. Using the adhesive composition 2, an unstretched polypropylene film was laminated on the obtained gas barrier layer with a dry lamination machine, and subjected to aging at 40° C. for three days to obtain a gas barrier composite film for a hydrothermally processable package according to Example 7.

### Comparative Example 1

A printing ink for lamination was printed on a corona-treated surface of a corona-treated polypropylene film (produced by a Toyobo Co., Ltd., trade name: “Pylen P-2161”, thickness: 25 μm), then an adhesive composition 5 was applied thereon, and after being dried, a gas barrier coating agent composition 2 was applied and dried to form a gas barrier layer with thickness of 0.3 μm. Using the adhesive composition 5, an unstretched polypropylene film was laminated on the obtained gas barrier layer with a dry lamination machine, and subjected to aging at 40° C. for three days to obtain a gas barrier composite film for a hydrothermally processable package according to Comparative Example 1.

### Comparative Example 2

A printing ink for lamination was printed on a corona-treated surface of a corona-treated polypropylene film (produced by a Toyobo Co., Ltd., trade name: “Pylen P-2161”, thickness: 25 μm), then an adhesive composition 6 was applied thereon, and after being dried, a gas barrier coating agent composition 2 was applied and dried to form a gas barrier layer with thickness of 0.3 μm. Using the adhesive composition 5, an unstretched polypropylene film was laminated on the obtained gas barrier layer with a dry lamination machine, and subjected to aging at 40° C. for three days to obtain a gas barrier composite film for a hydrothermally processable package according to Comparative Example 2.

### <Evaluation>

The obtained gas barrier composite films for a hydrothermally processable package were evaluated by the following methods. Table 2 shows the results.

TABLE 2

| | | Example | | | | | | | Comparative Example | |
|---|---|---|---|---|---|---|---|---|---|---|
| Constitution | | 1 | 2 | 3 | 4 | 5 | 6 | 7 | 1 | 2 |
| Printing ink composition | | absent | absent | absent | absent | absent | absent | present | absent | absent |
| Adhesive composition No. | | 2 | 2 | 2 | 1 | 3 | 4 | 2 | 5 | 6 |
| Gas barrier coating agent composition No. | | 1 | 2 | 3 | 2 | 2 | 2 | 2 | 2 | 2 |
| Adhesive composition No. | | 2 | 2 | 2 | 1 | 3 | 4 | 2 | 5 | 6 |
| <Evaluation> | | | | | | | | | | |
| Adhesiveness to base film | | A | A | A | A | A | A | A | A | A |
| Laminate adhesion (N/cm) | | 200 | 200 | 220 | 200 | 200 | 200 | 200 | 200 | 200 |
| Heat seal strength (N/cm) | | 3 | 3 | 3.1 | 3 | 3 | 3 | 3 | 3 | 3 |
| Oxygen permeability | 0% RH | 0.1 or | 0.1 or | 0.1 or | 0.1 or | 0.1 or | 0.1 or | 0.1 or | 0.1 or | 0.1 or |
| | | less | less | less | less | less | less | less | less | less |
| (cm³/m² · day · kPa) | 90% RH | 40 | 20 | 10 | 20 | 20 | 20 | 20 | 20 | 20 |
| Adaptability for boiling | | A | A | A | A | A | A | A | B | B |

### (Adhesiveness to Base Film)

Nicks with a length of approximately 3 to 4 cm were made in the shape of “x” on the surface of each of the gas barrier composite films for a hydrothermally processable package according to Examples 1 to 7 and Comparative Examples 1 and 2 with a cutter knife, and a cellophane tape was stuck to the nicked surface. The sticking cellophane tape was peeled off at a stroke, and the state of peeling of the thin coating layer was visually observed. Based on the state of peeling, adhesiveness to base film was evaluated in the following criteria.
A: no peeling
B: a slight extent of peeling observed

### (Laminate Adhesion)

Each of the gas barrier composite films for a hydrothermally processable package according to Examples 1 to 7 and Comparative Examples 1 and 2 was cut to a width of 15 mm, and measured for T-type peel strength on a peel tester (produced by Yasuda Seiki K. K.) at a peeling speed of 300 mm/min.

### (Heat Sealability)

Each of the gas barrier composite films for a hydrothermally processable package according to Examples 1 to 7 and Comparative Examples 1 and 2 was formed into a bag by using an impulse sealer (produced by Fuji Impulse Sealer), and measured for heat seal strength on a peel tester (produced by Yasuda Seiki K. K.) at a peeling speed of 300 mm/min.

### (Oxygen Transmission Rate)

Oxygen transmission rate (OTR value) measurements were carried out according to JIS K 7126 Method B using an oxygen transmission rate test system (trade name: “OX-TRAN 100”, produced by Mocon Inc.). Here, the measurements were carried out in an atmosphere of 23° C., and 0% RH and 90% RH (relative humidity).

By using two gas barrier composite films for a hydrothermally processable package with a size of 20 cm×20 cm, each of the gas barrier composite films for a hydrothermally processable package according to Examples 1 to 7 and Comparative Examples 1 and 2 was formed into a bag having the same volume. The resultant bag was packed with water, thereafter heat sealed, and evaluated for adaptability for boiling. Table 1 shows the results.

### <Adaptability for Boiling >

Each of the heat-sealed formed bags was immersed in hot water of 95° C. for 30 minutes, and adaptability for boiling is evaluated by judging as to whether or not each of the heat-sealed formed bags suffered any delamination.

Evaluation . A: showing no signs delamination
B: displaying delamination

### INDUSTRIAL APPLICABILITY

By using a gas barrier composite film of the present invention, it is possible to provide: a gas barrier composite film that has a favorable adhesion between a gas barrier resin and other layers and which has hydrothermal processability upon forming it into a packaging bag; and a packaging bag obtained by using the gas barrier composite film.

1. A gas barrier composite film for a hydrothermally processable package,
wherein at least one gas barrier layer comprising a gas barrier resin and an inorganic layered compound is interposed between a base film layer and a sealing material layer, and
an adhesive layer is further formed on both sides of the gas barrier layer by applying an adhesive composition comprising: a base material mainly comprising a polyurethane resin having at least one functional group selected from the group consisting of an amino group, a hydroxyl group, and a carboxyl group; and a curing agent comprising an isocyanate curing agent and an epoxy curing agent, at the following functional group ratio:
I/P=0.3 to 30.0
E/P=1.5 to 25.0
(here, “P” represents the total number of moles of primary and secondary amino groups, hydroxyl groups, and carboxyl groups contained in the base material, “I” represents the number of moles of isocyanate groups contained in the isocyanate curing agent, and “E” represents the number of moles of epoxy groups contained in the epoxy curing agent).

2. The gas barrier composite film for a hydrothermally processable package according to claim 1,
wherein said polyurethane resin has a weight-average molecular weight of 5000 to 200000.

3. The gas barrier composite film for a hydrothermally processable package according to claim 1 or 2,
wherein said gas barrier layer comprises said gas barrier resin and said inorganic layered compound in a mass ratio in the range of (30/70) to (70/30).

4. The gas barrier composite film for a hydrothermally processable package according to claim 1 or 2, wherein said gas barrier resin is at least one selected from the group consisting of a polyvinyl alcohol copolymer and an ethylene-vinyl alcohol copolymer.

5. The gas barrier composite film for a hydrothermally processable package according to claim 1 or 2, further comprising a printed layer interposed between the base film layer and the sealing material layer.

6. A packaging bag,
which is obtained by forming into a bag the gas barrier composite film for a hydrothermally processable package according to claim 1 or 2.
